(19) United States
(12) Patent Application Publication
(10) Pub. No.: US 2022/0224604 A1
(43) Pub. Date: Jul. 14, 2022

(54) MPTCP INCAST PERFORMANCE EVALUATION MODEL BASED ON A QUEUING NETWORK

(71) Applicant: CHINA UNIVERSITY OF PETROLEUM, Shandong (CN)

(72) Inventors: Shanchen Pang, Shandong (CN); Jiamin Yao, Shandong (CN); Xun Wang, Shandong (CN); Shuyu Wang, Shandong (CN); Tong Ding, Shandong (CN)

(73) Assignee: CHINA UNIVERSITY OF PETROLEUM, Shandong (CN)

(21) Appl. No.: 16/968,609

(22) PCT Filed: Dec. 23, 2019
(86) PCT No.: PCT/CN2019/127418

§ 371 Date: Aug. 10, 2020

(30) Foreign Application Priority Data
May 29, 2019 (CN) 201910457432.8

(51) Int. Cl. H04L 41/14; H04L 43/0888; H04L 43/18

(52) U.S. Cl. CPC H04L 41/145; H04L 43/18; H04L 43/0888

(57) ABSTRACT

An MPTCP Incast performance evaluation model based on a queuing network is provided. The invention establishes a multi-level collaborative MPTCP Incast data transmission performance evaluation model of M/M/N/m^{I}→M/M/L/m^{II}→M/M/K/m^{III} the queuing network based on a multi-homed FatTree topology and a Markov property of an MPTCP data scheduling process. M/M/N/m^{I}, M/M/L/m^{II} and M/M/K/m^{III} respectively characterize a three-level collaborative process of arrival of data traffic groups in a bottleneck link of an edge layer, a transmission hotspot ToR cluster and a bottleneck link of a convergence layer.

### BACKGROUND OF THE INVENTION

### Technical Field

The invention relates to a protocol performance evaluation model, in particular to an MPTCP Incast performance evaluation model based on a queuing network.

### Background Art

MPTCP is an important protocol to deal with an Incast communication mode on a data center network, which can maintain a good load balance of transmitted data and increase aggregate bandwidth. However, in the Incast communication mode of a FatTree topology, the MPTCP protocol has a performance bottleneck of throughput collapse. A many-to-one communication mode widely exists in data center networks, such as cluster-based storage systems and MapReduce-based applications, resulting in a significant drop in the throughput of the TCP protocol. With the advent of IPv6, multi-homed hosts have become popular. Even for the widely used IPv4, the use of multi-homed hosts is increasing. Using MPTCP based on multi-homed technology to support multiplexing of redundant link resources [5] and maintain a load balance has become an important research subject in the current Internet field to deal with TCP Incast.

In the Incast communication mode, only when all of the sending ends have completed the current round of parallel transmissions will the next round of data block transmissions start. In a multi-homed Fat-tree data center network topology, the buffer pool of a commercial Ethernet switch is small. When a plurality of sub-streams inject traffics into a bottleneck link of an edge layer, a large number of data packets overflow from buffer pools of ToP-of-Rack Switches (ToRs), resulting in throughput collapse of a ToR transmission hotspot. Since MPTCP follows the packet loss driving mechanism of the traditional TCP/IP protocol, some packet losses cannot be quickly retransmitted for recovery, and further, since the time of a timeout retransmission is much longer than the delay of an end-to-end round-trip transmission, a large number of timeout retransmissions cause the link to be idle, resulting in a drop in the throughput of a receiving end. Therefore, it is necessary to study the performance bottleneck and transmission delay of the bottleneck link and the ToR cluster performing data grouping and forwarding in the MPTCP Incast mode.

Existing performance analysis mechanisms of the MPTCP model are as follows: an MPTCP single sub-stream model, a Markov model based on a joint congestion control mechanism, and a deterministic time Markov model for parallel multipath transmissions. The above studies did not carry out formalized definition or any performance modeling analysis on the problem of MPTCP Incast throughput collapse. More and more studies show that multi-homed technology will become the core technology of the current data center network, and the research community lacks the theoretical analysis and performance evaluation of the problem of MPTCP Incast throughput collapse based on a discrete grouping model.

### SUMMARY OF THE INVENTION

In order to overcome the shortcomings of the existing model, the invention provides an MPTCP Incast performance evaluation model based on a queuing network. The invention establishes a multi-level collaborative MPTCP Incast data transmission performance evaluation model of M/M/N/m^{I}→M/M/L/m^{II}→M/M/K/m^{III} on a queuing network by using a multi-homed FatTree topology and a Markov property of an MPTCP data scheduling process. M/M/N/m^{I}, M/M/L/m^{II} and M/M/K/m^{III} respectively characterize a three-level collaborative process of arrival of data traffic groups in a bottleneck link of an edge layer, a transmission hotspot ToR cluster and a bottleneck link of a convergence layer. The model provided by the invention calculates an end-to-end data transmission average delay and analyzes delay performance of MPTCP Incast throughput collapse, thereby providing a theoretical basis for MPTCP Incast performance analyses.

The technical solutions used by the invention are as follows:

An MPTCP Incast performance evaluation model based on a queuing network, including the following portions:

A. Analyzing an MPTCP Incast data transmission process, and establishing a queuing model of M/M/N/m^{I}→M/M/L/m^{II}→M/M/K/m^{III} including a Level I service system, a Level II service system and a Level III service system;

B. Establishing a multi-level collaborative MPTCP Incast data transmission performance queuing system and performing a solver calculation; and

C. Calculating an MPTCP Incast average forwarding delay.

During the portion A, the Level I service system, the Level II service system and the Level III service system analyze a process of arrival of data traffic groups in a bottleneck link and a transmission hotspot ToR cluster, and respectively characterize bottleneck link performance of an edge layer, processing performance of the transmission hotspot ToR cluster and bottleneck link performance of a convergence layer.

During the portion B, the three-level service system respectively solves queuing models of the Level I service system, the Level II service system and the Level III service system: Step 1, defining a transmission intensity; Step 2, establishing a life-and-death status transition diagram of the model; Step 3, calculating a probability of stability and an initial idle probability of a birth-and-death process of the system; and Step 4, solving average processing time of the system according to the Little's formula in which:

(1) The transmission intensity of each service system is defined as:

$$ρ = \frac{λ}{μ} .$$

(2) A balance formula of the system is:

$${P}_{0} = \{ \begin{matrix}{[ {\sum }_{n = 0}^{K - 1} \frac{{( K ρ )}^{n}}{n !} + \frac{{( K ρ )}^{K}}{m !} \cdot ( \frac{1}{1 - ρ} - \frac{{ρ}^{{m}^{III} - K - 1}}{1 - ρ} ) ]}^{- 1} , ρ \neq 1 \\ {[ {\sum }_{n = 0}^{K - 1} \frac{{( K )}^{n}}{n !} + \frac{{( K )}^{K}}{K !} \cdot ( {m}^{III} - K + 1 ) ]}^{- 1} , ρ = 1\end{matrix} , \\ {P}_{n} = \{ \begin{matrix}\frac{{( K ρ )}^{n}}{n !} {P}_{0} , 1 < n < K - 1 \\ \frac{{K}^{K}}{K !} {ρ}^{n} {P}_{0} , K < n < {m}^{III}\end{matrix} ;$$

(3) An average waiting queue length of the system is set to E(Q_{d}), which is:

$${E}^{III} ( {Q}_{d} ) = \{ \begin{matrix}\frac{{( K ρ )}^{K}}{N !} ρ {\sum }_{n = K + 1}^{{m}^{III}} ( n - K ) {ρ}^{n - K - 1} {P}_{0} , ρ \neq 1 \\ \frac{{K}^{K}}{2 K !} {P}_{0} \cdot ( {m}^{III} - K + 1 ) ( {m}^{III} K ) , ρ = 1\end{matrix} ; and$$

(4) The average processing time of the system is:

$$E ( {{T}_{q}}^{III} ) = \frac{{E}^{III} ( {{Q}^{III}}_{d} )}{λ} = \{ \begin{matrix}\frac{{( K ρ )}^{K} ρ}{K ! {( 1 - ρ )}^{2} ( 1 - {P}_{{m}^{III}} ) λ} {P}_{0} [ 1 - ( {m}^{III} - K + 1 ) ] {ρ}^{{m}^{III} - K} , ρ \neq 1 \\ \frac{{N}^{N} {P}_{0}}{2 N ! ( 1 - {P}_{{m}^{III}} ) λ} ( {m}^{III} K ) ( {m}^{III} K + 1 ) , ρ = 1\end{matrix} .$$

During the portion C, after modeling the sub-level service systems, the average forwarding and processing delay of MPTCP in the Incast communication mode is calculated as follows:

E(T_{q})=E(T_{q}^{I})+E(T_{q}^{II})+E(T_{q}^{III}).

The beneficial effects brought by the technical solutions provided by the invention are:

By combining the queuing network and the MPTCP Incast performance evaluation system and making full use of the Markov property of an MPTCP data scheduling process, the invention calculates an end-to-end data transmission average delay and analyzes delay performance of MPTCP Incast throughput collapse based on the model. The model provided by the present invention has high accuracy for its estimated delay is close to the actual measured delay, thereby providing a theoretical basis for MPTCP Incast performance analyses.

### BRIEF DESCRIPTION OF THE DRAWINGS

In order to more clearly explain the technical solutions of the invention, the drawings required in the contents of the invention will be briefly described below.

FIG. 1 is a structural diagram of a multi-home-based FatTreePoD according to the invention, wherein k sets of n-homed hosts are simultaneously connected to a ToR cluster, the number of which is n, through N sub-streams. A link set P becomes a bottleneck and the ToR becomes a transmission hotspot.

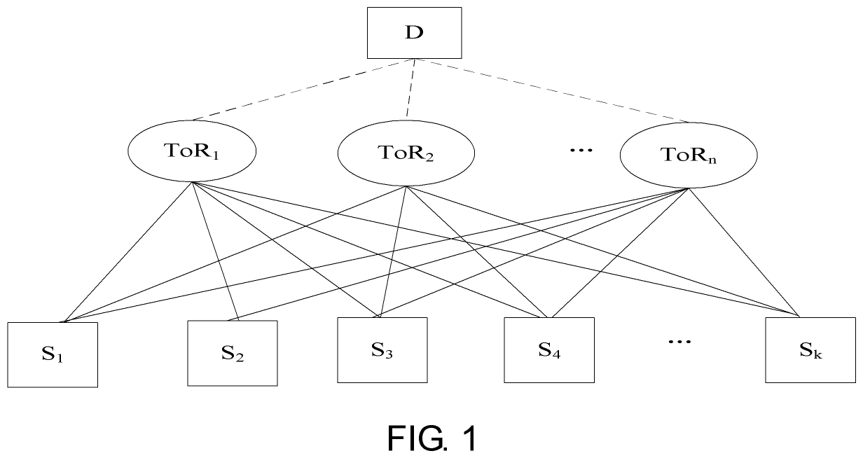

FIG. 2 is a multi-level collaborative MPTCP Incast data transmission performance model system, which is composed of three levels of queuing service systems, based on the multi-level series queuing theory according to the present.

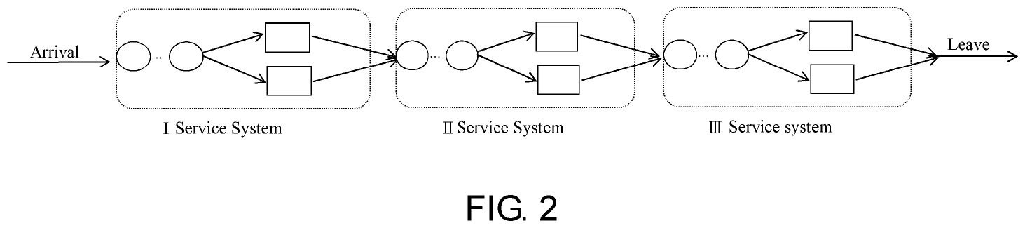

FIG. 3 is a multi-level collaborative MPTCP Incast data transmission performance model of M/M/N/m^{I}→M/M/L/m^{II}→M/M/K/m^{III} based on a multi-homed FatTree topology and a Markov property of an MPTCP data scheduling process.

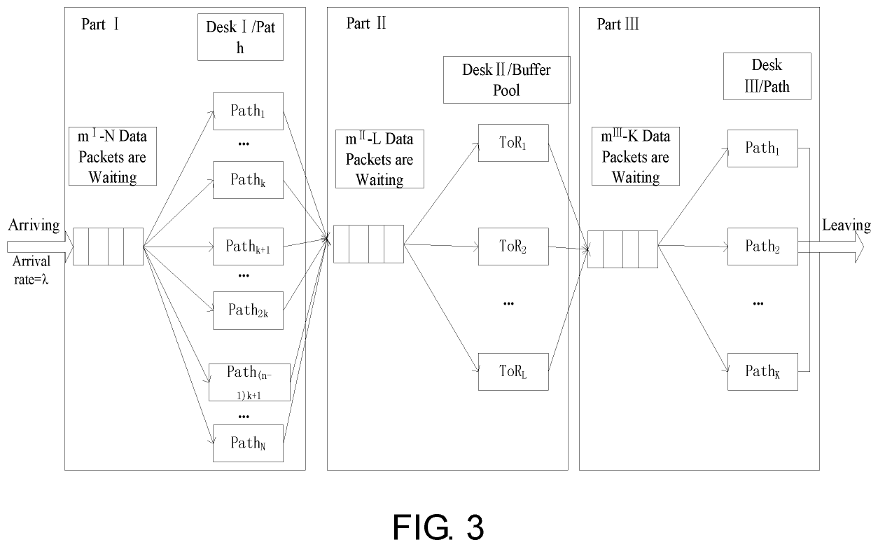

### DETAILED DESCRIPTION OF THE INVENTION

To make the objectives, technical solutions and advantages of the invention clearer, the embodiments of the invention will be described in further detail below.

### Example 1

The basis of this embodiment lies in an analysis of an MPTCP Inast transmission process with two layers of network. With the introduction of dual-homed hosts, the number of links at each layer is increased to achieve full connection between switch devices at different layers. In order to effectively quantify the performance of an MPTCP Incast data transmission, an NS3 simulation tool is used in the experiment to simulate the transmission process of a multi-homed FatTree topology MPTCP in a data center. Here we take a dual-homed FatTree topology as an example and use a TCP-newReno algorithm. First, a process is simulated in which data is sent from a plurality of multi-homed hosts to the same receiving end through two ToR switches until a ToR cluster message cache is exhausted. Six sets of experiments are conducted to measure the average delay of data groups passing through the dual-homed FatTree topology. Then, the number of controllers in the ToRs cluster is set to 3 and 6 sets of experiments are conducted. The estimated delay of this model is closer to the actual measured delay. The actual measured delay is generally larger than the estimated value of the model of M/M/N/m^{I}-M/M/L/m^{II}-M/M/K/m^{III}. This is because the delay measured by the tool includes I/O delay, transmission delay and the like except for message stay time. In addition, as the number of switches increases, the deviation between the estimated value and the measured delay of the model becomes larger and larger. This is because the batch model equates the number of messages in each batch to the number of switches, which makes the estimated delay of messages multiplied and thus accurate estimation of the actual delay of messages impossible.

What is claimed is:

1. An MPTCP Incast performance evaluation model based on a queuing network, comprising the following portions:
A. Analyzing an MPTCP Incast data transmission process, and establishing a queuing model of M/M/N/m^{I}→M/M/L/m^{II}→M/M/K/m^{III} comprising a Level I service system, a Level II service system and a Level III service system;
B. Establishing a multi-level collaborative MPTCP Incast data transmission performance queuing system and performing a solver calculation; and
C. Calculating a MPTCP Incast average forwarding delay.

2. The MPTCP Incast performance evaluation model based on a queuing network according to claim 1, wherein in the portion A, in the multi-level collaborative MPTCP Incast data transmission performance queuing system, the Level I service system, the Level II service system and the Level III service system analyze an arrival process of data traffic groups in a bottleneck link and a transmission hotspot ToR cluster, and respectively characterize a bottleneck link performance of an edge layer, processing performance of the transmission hotspot ToR cluster and the bottleneck link performance of a convergence layer.

3. The MPTCP Incast performance evaluation model based on a queuing network according to claim 1, wherein in the portion B, a three-level service system is to solve queuing models of the Level I service system, the Level II service system and the Level III service system respectively: Step 1, defining a transmission intensity; Step 2, establishing a life-and-death status transition diagram of the model; Step 3, calculating a probability of stability and an initial idle probability of a birth-and-death process of the system; and Step 4, solving an average processing time of the system according to the Little's formula in which:
(1) The transmission intensity of each service system is defined as:
$$ρ = \frac{λ}{μ} ;$$
(2) A balance formula of the system is:
$${P}_{0} = \{ \begin{matrix}{[ {\sum }_{n = 0}^{K - 1} \frac{{( K ρ )}^{n}}{n !} + \frac{{( K ρ )}^{K}}{m !} \cdot ( \frac{1}{1 - ρ} - \frac{{ρ}^{{m}^{III} - K - 1}}{1 - ρ} ) ]}^{- 1} , ρ \neq 1 \\ {[ {\sum }_{n = 0}^{K - 1} \frac{{( K )}^{n}}{n !} + \frac{{( K )}^{K}}{K !} \cdot ( {m}^{III} - K + 1 ) ]}^{- 1} , ρ = 1\end{matrix} , \\ {P}_{n} = \{ \begin{matrix}\frac{{( K ρ )}^{n}}{n !} {P}_{0} , 1 < n < K - 1 \\ \frac{{K}^{K}}{K !} {ρ}^{n} {P}_{0} , K < n < {m}^{III}\end{matrix} ;$$
(3) An average waiting queue length of the system is set to E(Q_{d}), which is:
$${E}^{III} ( {Q}_{d} ) = \{ \begin{matrix}\frac{{( K ρ )}^{K}}{N !} ρ {\sum }_{n = K + 1}^{{m}^{III}} ( n - K ) {ρ}^{n - K - 1} {P}_{0} , ρ \neq 1 \\ \frac{{K}^{K}}{2 K !} {P}_{0} \cdot ( {m}^{III} - K + 1 ) ( {m}^{III} - K ) , ρ = 1\end{matrix} ; and$$
(4) The average processing time of the system is:
$$E ( {{T}_{q}}^{III} ) = \frac{{E}^{III} ( {{Q}^{III}}_{d} )}{λ} = \{ \begin{matrix}\frac{{( K ρ )}^{K} ρ}{K ! {( 1 - ρ )}^{2} ( 1 - {P}_{{m}^{III}} ) λ} {P}_{0} [ 1 - ( {m}^{III} - K + 1 ) ] {ρ}^{{m}^{III} - K} , ρ \neq 1 \\ \frac{{N}^{N} {P}_{0}}{2 N ! ( 1 - {P}_{{m}^{III}} ) λ} ( {m}^{III} K ) ( {m}^{III} K + 1 ) , ρ = 1\end{matrix} .$$
